(19) United States
(12) Patent Application Publication
(10) Pub. No.: US 2024/0229651 A9
(43) Pub. Date: Jul. 11, 2024

(54) TURBINE BLADE, METHOD OF MANUFACTURING A TURBINE BLADE AND METHOD OF REFURBISHING A TURBINE BLADE

(71) Applicant: Siemens Energy Global GmbH & Co. KG, München (DE)

(72) Inventors: Stephen Williamson, McAdenville, NC (US); Lieke Wang, Oviedo, FL (US); Mehmet Gungor, Orlando, FL (US); Nan Jiang, Charlotte, NC (US)

(21) Appl. No.: 17/769,363

(22) PCT Filed: Oct. 1, 2020
(86) PCT No.: PCT/US2020/070604

§ 371 Date: Apr. 15, 2022

Related U.S. Application Data
(60) Provisional application No. 62/926,728, filed on Oct. 28, 2019.

(51) Int. Cl. F01D 5/18

(52) U.S. Cl. CPC F01D 5/189; F01D 5/186; F05D 2230/21; F05D 2230/80

(57) ABSTRACT

A turbine blade includes an airfoil section, wherein at least one cooling hole is formed a tip floor of the airfoil section, which is fluidically connected to an internal coolant cavity of the airfoil section. The turbine blade further includes an additively manufactured tip cap formed via layer-by-layer deposition of material directly over the tip floor of the airfoil section. The tip cap includes at least one squealer tip rail extending outward from the tip floor. The at least one squealer tip rail comprises an embedded cooling channel formed therein. The embedded cooling channel is aligned with and fluidically connected to the at least one cooling hole formed through the tip floor of the airfoil section. The embedded cooling channel comprises one or more outlets located on at least one of a side face and a top face of the at least one squealer tip rail.

### BACKGROUND

### 1. Field

The present disclosure relates to turbine blades for gas turbine engines, and in particular to turbine blade tips.

### 2. Description of the Related Art

In a turbomachine, such as a gas turbine engine, air is pressurized in a compressor section and then mixed with fuel and burned in a combustor section to generate hot combustion gases. The hot combustion gases are expanded within a turbine section of the engine where energy is extracted to produce useful work, such as turning a generator to produce electricity. The hot combustion gases travel through a series of turbine stages within the turbine section. A turbine stage may include a row of stationary airfoils, i.e., turbine vanes, followed by a row of rotating airfoils, i.e., turbine blades, where the turbine blades extract energy from the hot combustion gases for providing output power.

Typically, a turbine blade comprises an airfoil extending span-wise radially outward from a platform. The airfoil is made up of an outer wall delimiting an airfoil interior which may have one or more internal cooling passages. A turbine blade also includes an attachment structure, referred to as a root, extending radially inward from the platform, for mounting the blade on a rotor disc. The radially outer tip of a turbine blade may be provided with a tip feature to reduce the size of a gap between the blades and a surrounding stationary shroud, referred to as a ring segment. The tip features, often referred to as squealer tips, are designed to minimize the leakage of the working fluid between the blade tips and the ring segment.

A squealer tip generally includes a tip rail extending radially outward from a tip cap. The tip rails, being located at a distance from the airfoil internal cooling passages, are therefore difficult cool by conduction. Typically, a squealer tip is cooled by drilling cooling holes on a pressure side surface and/or on a tip cap of the airfoil.

### SUMMARY

Briefly, aspects of the present disclosure provide a turbine blade with improved tip cooling.

According to a first aspect, a turbine blade is provided. The turbine blade comprises an airfoil section extending span-wise from a platform at a first end to a tip floor at a second end of the airfoil section. At least one cooling hole is formed through the tip floor. The at least one cooling hole is fluidically connected to an internal coolant cavity of the airfoil section. The turbine blade further comprises an additively manufactured tip cap formed via layer-by-layer deposition of material directly over the tip floor of the airfoil section. The tip cap comprises at least one squealer tip rail extending outward from the tip floor. The at least one squealer tip rail comprises an embedded cooling channel formed therein. The embedded cooling channel is aligned with and fluidically connected to the at least one cooling hole formed through the tip floor of the airfoil section. The embedded cooling channel comprises one or more outlets located on at least one of a side face and a top face of the at least one squealer tip rail.

According to a second aspect, a method for manufacturing a turbine blade is provided. The method comprises forming an airfoil section extending span-wise from a platform at a first end to a tip floor at a second end of the airfoil section. The method further comprises forming at least one cooling hole through the tip floor, the at least one cooling hole being fluidically connected to an internal coolant cavity of the airfoil section. The method further comprises forming a tip cap over the tip floor of the airfoil section, the tip cap comprising at least one squealer tip rail extending outward from the tip floor. The tip cap is formed additively via layer-by-layer deposition of material directly over the tip floor such that the at least one squealer tip rail comprises an embedded cooling channel formed therein. The embedded cooling channel is aligned with and fluidically connected to the at least one cooling hole formed through the tip floor of the airfoil section. The embedded cooling channel comprises one or more outlets located on at least one of a side face and a top face of the at least one squealer tip rail.

According to a third aspect, a method for refurbishing a turbine blade is provided. The method comprises removing material from a tip portion of the turbine blade up to a specified depth, to define a tip floor of an airfoil section of the turbine blade. The method further comprises drilling at least one cooling hole through the tip floor, the at least one cooling hole being fluidically connected to an internal coolant cavity of the airfoil section. The method further comprises forming a tip cap over the tip floor, the tip cap comprising at least one squealer tip rail extending outward from the tip floor. The tip cap is formed additively via layer-by-layer deposition of material directly over the tip floor such that the at least one squealer tip rail comprises an embedded cooling channel formed therein. The embedded cooling channel is aligned with and fluidically connected to the at least one cooling hole formed through the tip floor of the airfoil section. The embedded cooling channel comprises one or more outlets located on at least one of a side face and a top face of the at least one squealer tip rail.

### BRIEF DESCRIPTION OF THE DRAWINGS

The disclosure is shown in more detail by help of figures. The figures show preferred configurations and do not limit the scope of the disclosure.

FIG. 1 is a perspective view of a turbine blade;

FIG. 2 is a cross-sectional view along the section II-II in FIG. 1;

FIG. 3 is a cross-sectional view of a tip section of a turbine blade, looking in an axial direction, according to a first embodiment;

FIG. 4 is a cross-sectional view along the section III-III in FIG. 3;

FIGS. 5 and 5A show a perspective view of the tip section of the turbine blade according to the first embodiment;

FIG. 6 is a cross-sectional view of a tip section of a turbine blade, looking in an axial direction, according to a second embodiment; and

FIG. 7 is a cross-sectional view along the section VII-VII in FIG. 6.

### DETAILED DESCRIPTION

In the present description: a) radial and axial directions are defined in relation to an axis of rotation of a turbine blade, in a row of turbine blades in a turbine stage; b) a chord-wise direction is understood to be a direction generally from the airfoil leading edge to the airfoil trailing edge or vice versa; c) a lateral direction is understood to be a direction generally from the airfoil pressure side to the airfoil suction side or vice versa, i.e., transverse to the chord-wise direction.

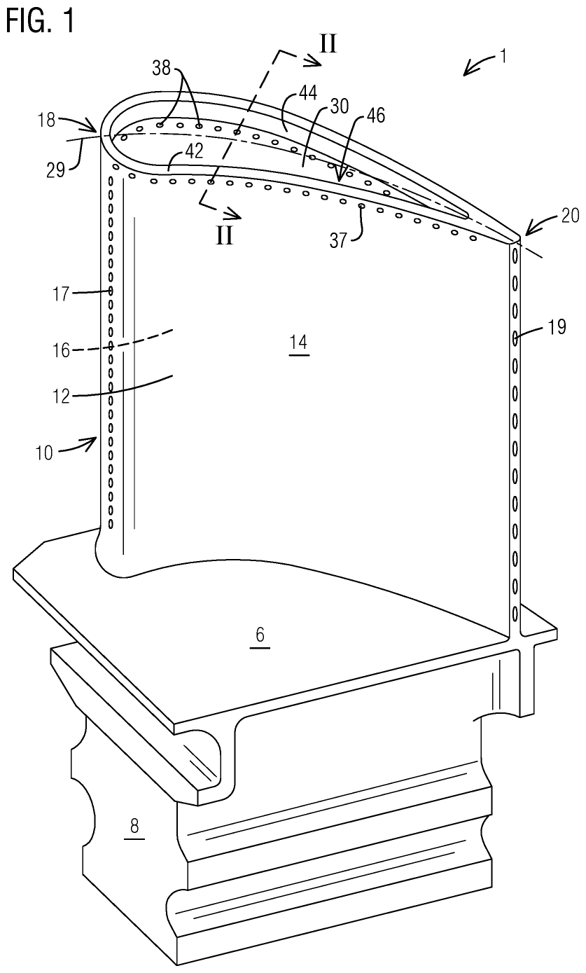

Aspects of the present disclosure relate to a turbine blade usable in a turbine stage of a gas turbine engine. A turbine stage comprises a circumferential row of turbine blades rotatable about an axis. FIG. 1 illustrates a single turbine blade 1. The blade 1 includes a generally hollow airfoil section 10 that extends span-wise in a radial direction from a blade platform 6 and into a stream of a hot gas path fluid. A root 8 extends radially inward from the platform 6 and may comprise, for example, a conventional fir-tree shape for coupling the blade 1 to a rotor disc (not shown). The airfoil section 10 comprises an outer wall 12 which is formed of a generally concave pressure side wall 14 and a generally convex suction side wall 16 joined together at a leading edge 18 and at a trailing edge 20, defining a camber line 29. The airfoil section 10 extends from the platform 6 at a radially inner end to a tip section 26 at a radially outer end, and may take any configuration suitable for extracting energy from the hot gas stream and causing rotation of the rotor disc.

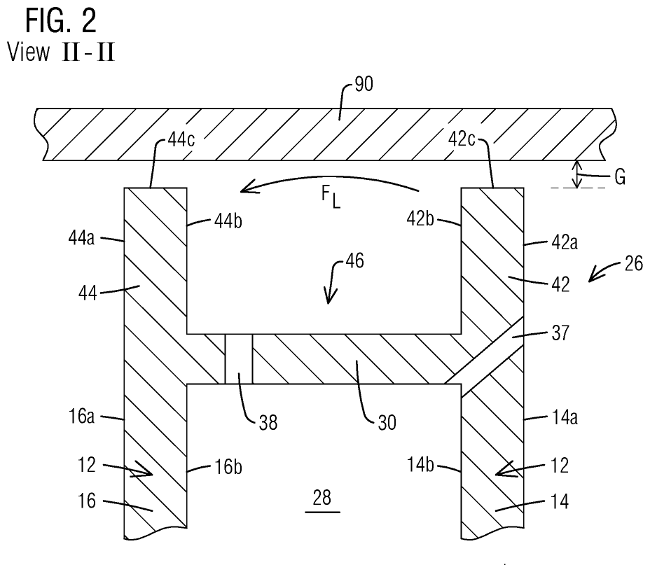

As shown in FIG. 2, the pressure side wall 14 comprises a laterally outer surface 14a exposed to the hot gas path fluid and a laterally inner surface 14b facing the airfoil interior. The suction side wall 16 comprises a laterally outer surface 16a exposed to the hot gas path fluid and a laterally inner surface 16b facing the airfoil interior. The interior of the hollow airfoil section 10 may comprise at least one internal coolant cavity 28 defined between the laterally inner surface 14b of the pressure side wall 14 and the laterally inner surface 16b of the suction side wall 16. The internal coolant cavity 28 may form part of an internal cooling system for the turbine blade 1. The internal cooling system may receive a coolant, such as air diverted from a compressor section (not shown), which may enter the internal coolant cavity 28 via coolant supply passages typically provided in the blade root 8. Within the internal coolant cavity 28, the coolant may flow in a generally radial direction, absorbing heat from the inner surfaces 14b, 16b of the pressure and suction side walls 14, 16, before being discharged via external orifices 17, 19, 37, 38 into the hot gas path (see FIGS. 1 and 2).

Particularly in high pressure turbine stages, the tip section 26 may be formed as a so-called “squealer tip”. Referring jointly to FIGS. 1 and 2, the tip section 26 may comprise a tip floor 30 disposed over the outer wall 12 at the radially outer end of the outer wall 12 and at least one squealer tip rail extending radially outward from the tip floor 30. In this case, a pressure side squealer tip rail 42 and a suction side squealer tip rail 44 are provided, which are spaced laterally to define a blade tip cavity 46 therebetween.

Referring to FIG. 2, the pressure side squealer tip rail 42 comprises a first lateral side face 42a flush with the pressure side wall 14, a second lateral side face 42b facing the blade tip cavity 46, and a radially outwardly facing top face 42c located at a radially outer tip of the pressure side squealer tip rail 42. The suction side squealer tip rail 44 comprises a first lateral side face 44a flush with the suction side wall 16, a second lateral side face 44b facing the blade tip cavity 46, and a radially outwardly facing top face 44c located at a radially outer tip of the suction side squealer tip rail 44. The tip section 26 may additionally include a plurality of cooling holes 37, 38 that fluidically connect the internal coolant cavity 28 with an external surface of the tip floor 30 exposed to the hot gas path fluid. In the shown example, the cooling holes 37 are formed through the pressure side wall 14, opening into the outer surface 14a, while the cooling holes 38 are formed through the tip floor 30 opening into the blade tip cavity 46.

The squealer tip rails 42, 44 are typically designed as sacrificial features in a turbine blade to maintain a small tip clearance G with a stationary ring segment 90, for better turbine efficiency and to protect the airfoil internal cooling system under the tip floor 30 in the event of the tip rubbing against the ring segment 90 during transient engine operation. A tip leakage flow F_{L} from the pressure side to the suction side through the tip clearance G not only causes reduced flow turning and torque generation, but also generates additional vortices and total pressure losses. It is therefore desirable to reduce the tip leakage flow F_{L} and total pressure losses near the blade tip.

Moreover, as seen from FIG. 2, the tip floor 30 generally receives convection cooling from the internal cooling system of the blade. The squealer tip rails 42, 44 extend away from the internal cooling system of the blade, because of which there may be a significant temperature gradient between the tip floor 30 and the squealer tip rails 42, 44. Furthermore, since the squealer tip rails 42, 44 are subject to rubbing against the ring segment 90, no thermal barrier coating is generally applied on the top faces 42c, 44c of the squealer tip rails 42, 44. As a result, severe oxidation may result in the squealer tip rails 42, 44 during engine operation, which may cause significant loss of the squealer tip and may widen the tip clearance G, thereby reducing turbine efficiency.

Traditionally, the turbine blade 1, including the platform 6, root 8, airfoil section 10 and the tip section 26, is formed integrally, typically via a casting process, which may limit the amount of cooling provided to the tip section 26.

Aspects of the present disclosure address at least some of the above-mentioned technical problems in connection with reduction of tip leakage flow and providing improved tip cooling. These aspects are realized by providing a turbine blade with an additively manufactured “squealer” tip having embedded cooling channels. The proposed cooling designs may allow a squealer tip design to survive extreme operating temperatures while reducing the required coolant consumption for tip cooling.

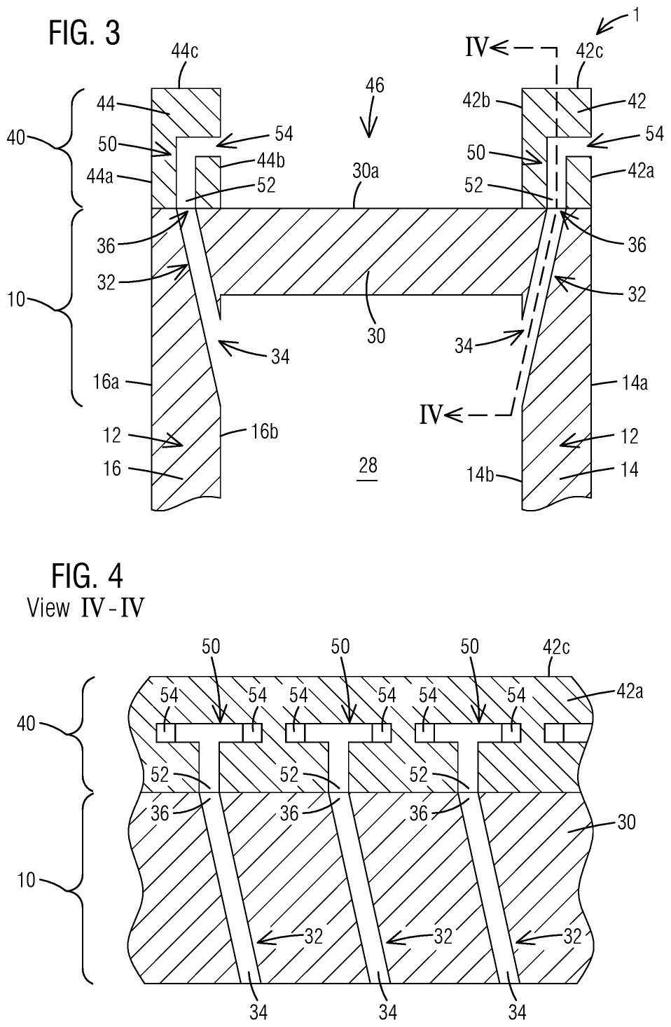

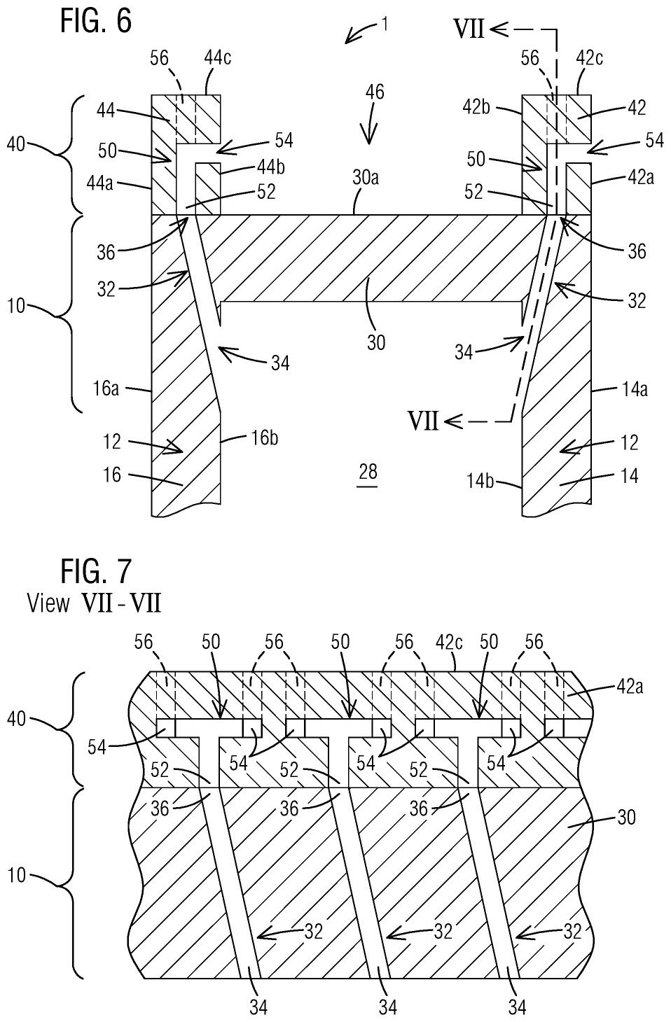

According to aspects of the present disclosure (e.g., see FIG. 3-7), a turbine blade 1 comprises an airfoil section 10 extending span-wise from a platform 6 at a first end (similar to FIG. 1) to a tip floor 30 at a second end of the airfoil section 10. The tip floor 30 extends laterally from the pressure side wall 14 to the suction side wall 16 and chord-wise from the leading edge 18 to the trailing edge 20 of the turbine blade, for example, as shown in FIGS. 3 and 6. At least one, but typically several cooling holes 32 may be formed through the tip floor 30. The cooling hole or holes 32 may have an outlet 36 located directly over the pressure side wall 14 or the section side wall 16. The cooling hole or holes 32 are fluidically connected to an internal coolant cavity 28 of the airfoil section 10. The blade 1 further includes a tip cap 40 formed by additive manufacturing by a layer-by-layer deposition of material directly over the tip floor 30 of the airfoil section 10. The tip cap 40 comprises at least one squealer tip rail 42, 44 extending radially outward from the tip floor 30. The squealer tip rail 42, 44 may further extend in a chord-wise direction between the leading edge 18 and the trailing edge 20 of the turbine blade. In the shown embodiments, a pair of squealer tip rails are provided, namely, a pressure side squealer tip rail 42 and a suction side squealer tip rail 44. The squealer tip rail or rails 42, 44 are additively formed so as to have one or more embedded cooling channels 50 formed therein. Each of the one or more embedded cooling channels 50 is aligned with and fluidically connected to a respective cooling hole 32 formed through the tip floor 30 of the airfoil section 10. Each of the one or more embedded cooling channels 50 comprises one or more outlets 54, 56 located a lateral side face 42a, 44b and/or a radially outwardly facing top face 42c, 44c of the respective squealer tip rail 42, 44.

The proposed cooling designs may address the above-mentioned heat transfer problems by placing back-side cooling closest to the area of highest heat transfer. Additionally, film coverage of the cooling air may be deliberate and controlled in the areas requiring greatest thermal protection. The physical features enabling improved thermal performance are the embedded cooling channels or micro-channels within the squealer tip rail, which form a semi-hollow squealer tip rail. These embedded cooling channels may be segregated in order to mitigate large scale cooling failure due to risk of tip rail cracking. Film coverage may be further improved at the outlets of the embedded cooling channels by the incorporating a shaped diffuser geometry.

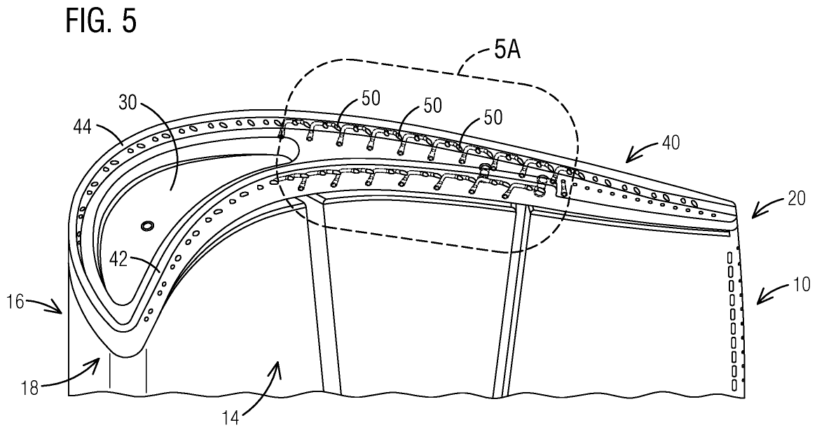

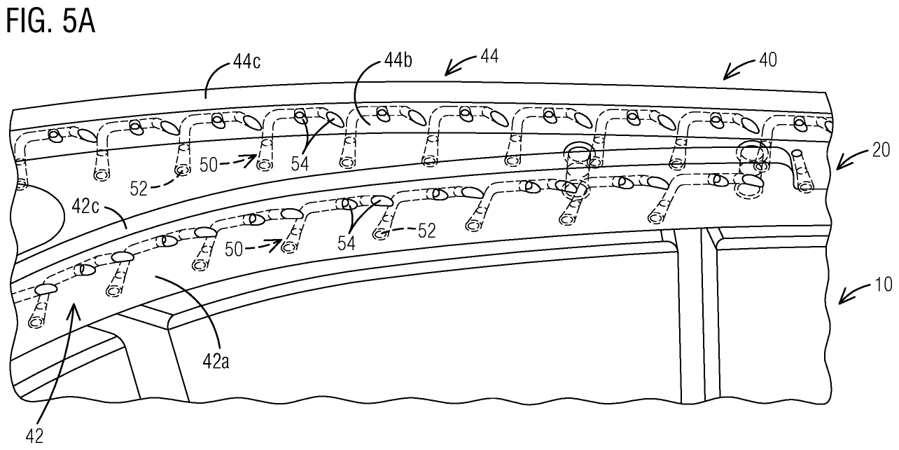

Referring now to FIG. 3-5, a first embodiment of an inventive turbine blade 1 is illustrated. The turbine blade 1 comprises an airfoil section 10 made up of an outer wall 12 comprising a generally concave suction side wall 14 and a generally convex suction side wall 16 (see FIG. 5). The airfoil section 10 comprises a tip floor 30 located at a radially outermost tip of the airfoil section 10. The airfoil section 10 may be formed, for example, by casting. A plurality of cooling holes 32 are formed through the tip floor 30. The cooling holes 32 may be arranged chordwise spaced from each other, as shown in FIG. 4. Each cooling hole 32 may have an inlet 34 located on an internal wall surface 14b, 16b facing the internal coolant cavity 28, and an outlet 36 located on a radially outer surface 30a of the tip floor 30. The outlet 36 of each cooling hole may be located directly over the pressure side wall 14 or the suction side wall 16. The cooling holes 32 through the tip floor 30 may be formed, for example, by a drilling process, such electrical discharge machining (EDM), among others.

The tip cap 40 may be formed over the airfoil section 10 via an additive manufacturing process, such as, selective laser melting (SLM), among others. In particular, the tip cap 40 may be formed by a layer-by-layer deposition of material directly over the tip floor 30 of the airfoil section 10. The additively manufactured tip cap 40 may comprise a pressure side squealer tip rail 42 and a suction side squealer tip rail 44. Each of the squealer tip rails 42, 44 is provided with a plurality of embedded cooling channels 50. The embedded cooling channels 50 are chord-wise spaced apart and form segregated cooling circuits connected to the airfoil core. Each embedded cooling channel 50 comprises an inlet 52 positioned over an outlet 36 of a respective cooling hole 32 formed through the tip floor 30. Each embedded cooling channel 50 may have multiple outlets 54. A single-inlet multiple-outlet cooling design, such as in this example, results in better use of the available cooling air (higher thermal efficiency) and overall reduction of cooling air consumption by the blade tip.

In the first embodiment, each embedded cooling channel 50 comprises two or more outlets 54 located chord-wise spaced on a side face of the of the respective squealer tip rail, as best seen in FIGS. 4 and 5. Specifically, in the shown example, the embedded cooling channels 50 on the pressure side squealer tip rail 42 have a pair of outlets 54 located on a first side face 42a of the pressure side squealer tip rail 42 flush with the pressure side wall 14 of the airfoil section. The embedded cooling channels 50 on the suction side squealer tip rail 44 have a pair of outlets 54 located on a second side face 44b of the suction side squealer tip rail 44 facing the blade tip cavity 46. The pair of outlets 54 may be located on either side of the inlet 52 (as shown), or may be both located on the same side of the inlet 52.

In a further variant, one or more of the embedded cooling channels may be provided with outlets located on a top surface of a squealer tip rail, alternate to or in addition to having outlets located on a lateral side face of the squealer tip rail. As an example, a second embodiment is illustrated referring to FIGS. 6 and 7. As per this embodiment, a turbine blade 1 may comprise an airfoil section 10 having a similar design and manufacture to that described in connection with the first embodiment. The tip cap 40 may be formed over the airfoil section 10 via an additive manufacturing process, such as, selective laser melting (SLM), among others. In particular, the tip cap 40 may be formed by a layer-by-layer deposition of material directly over the tip floor 30 of the airfoil section 10. As shown, the additively manufactured tip cap 40 may comprise a pressure side squealer tip rail 42 and a suction side squealer tip rail 44. Each of the squealer tip rails 42, 44 is provided with a plurality of embedded cooling channels 50. The embedded cooling channels 50 are chord-wise spaced apart and form segregated cooling circuits connected to the airfoil core. Each embedded cooling channel 50 comprises an inlet 52 positioned over an outlet 36 of a respective cooling hole 32 through the tip floor 30, and is provided with multiple outlets 54, 56. In the present example, each embedded cooling channel 50 is provided with four outlets, namely a first pair of chord-wise spaced outlets 54 formed on a lateral side face 42a, 44b of the respective squealer tip rail 42, 44, and a second pair of chord-wise spaced outlets 56 formed on a top face 42c, 44c of the respective squealer tip rail 42, 44.

The use of single-inlet multi-outlet cooling channels as described in the second embodiment may result in a wider coverage for convective heat transfer using minimum coolant flow, thereby increasing turbine efficiency. The outlets 56 located on the top face 42c, 44c may ensure improved convective cooling along the radial height of the squealer tip rail 42, 44. The outlets 54 located on the lateral side face 42a, 44b (which are at a distance from the top face 42c, 44c) may ensure that the blade tip continues to be cooled in the event the outlets 56 get clogged due to rubbing of the squealer tip wall 42, 44 against the ring segment during transient engine operation. Thus, an effective cooling to the blade tip may be provided to achieve a longer blade life.

The present technique provides freedom in the design of a blade tip cooling scheme through the process of printing the full tip feature on top of the an already formed blade airfoil. An aspect of the present technique may be directed to a method for repairing or refurbishing a turbine blade, for example, a blade that was manufactured by conventional casting. The process may involve removing material from a tip portion of a used blade up to a specified depth, to define a tip floor of the airfoil section, and subsequently forming a tip cap by additive manufacturing directly over the tip floor of the airfoil section, in accordance with any of the embodiments and variants described above. The interface between cast part and the additively manufactured part may serve as a junction between the cooling air source and the embedded micro channels.

While specific embodiments have been described in detail, those with ordinary skill in the art will appreciate that various modifications and alternative to those details could be developed in light of the overall teachings of the disclosure. Accordingly, the particular arrangements disclosed are meant to be illustrative only and not limiting as to the scope of the invention, which is to be given the full breadth of the appended claims, and any and all equivalents thereof.

1. A turbine blade comprising:
an airfoil section extending span-wise from a platform at a first end to a tip floor at a second end of the airfoil section,
wherein at least one cooling hole is formed through the tip floor, the at least one cooling hole being fluidically connected to an internal coolant cavity of the airfoil section, and
an additively manufactured tip cap formed via layer-by-layer deposition of material directly over the tip floor of the airfoil section, the tip cap comprising:
at least one squealer tip rail extending outward from the tip floor, the at least one squealer tip rail having an embedded cooling channel formed therein,
wherein the embedded cooling channel is aligned with and fluidically connected to the at least one cooling hole formed through the tip floor of the airfoil section, the embedded cooling channel having one or more outlets located on at least one of a side face and a top face of the at least one squealer tip rail.

2. The turbine blade according to claim 1, wherein the embedded cooling channel comprises a single inlet and multiple outlets.

3. The turbine blade according to claim 1, wherein an outlet of the at least one cooling hole is located directly over a pressure side wall or a suction side wall of the airfoil section.

4. The turbine blade according to claim 1, wherein the inlet of the embedded cooling channel is positioned over an outlet of the cooling hole at the tip floor of the airfoil section.

5. The turbine blade according to claim 1, wherein the embedded cooling channel comprises two or more outlets located chord-wise spaced on the side face of the at least one squealer tip rail.

6. The turbine blade according to claim 1, wherein the embedded cooling channel comprises at least one first outlet located on the side face and at least one second outlet located on the top face of the at least one squealer tip rail.

7. The turbine blade according to claim 1, wherein the at least one squealer rail comprises a pressure side squealer rail having a first side face flush with a pressure side wall of the airfoil section and a second side face facing a blade tip cavity.

8. The turbine blade according to claim 7, wherein the embedded cooling channel formed in the pressure side squealer tip rail comprises at least one outlet located on the first side face of the pressure side squealer tip rail.

9. The turbine blade according to claim 1, wherein the at least one squealer rail comprises a suction side squealer rail having a first side face flush with a suction side wall of the airfoil section and a second side face facing a blade tip cavity.

10. The turbine blade according to claim 9, wherein the embedded cooling channel formed in the suction side squealer tip rail comprises at least one outlet located on the second side face of the suction side squealer tip rail.

11. The turbine blade according to claim 1,
wherein a plurality of chord-wise spaced cooling holes are formed through the tip floor, the plurality of cooling holes being fluidically connected to an internal coolant cavity of the airfoil section,
wherein the at least one squealer tip rail comprises a plurality of chord-wise spaced embedded cooling channels formed therein, and
wherein each embedded cooling channel of the plurality of embedded cooling channels is aligned with and fluidically connected to a respective cooling hole of the plurality of cooling holes formed through the tip floor, said each embedded cooling channel having one or more outlets located on at least one of a side face and a top face of the at least one squealer tip rail.

12. A method for manufacturing a turbine blade, comprising:
forming an airfoil section extending span-wise from a platform at a first end to a tip floor at a second end of the airfoil section,
forming at least one cooling hole through the tip floor, the at least one cooling hole being fluidically connected to an internal coolant cavity of the airfoil section, and
forming a tip cap over the tip floor of the airfoil section, the tip cap comprising at least one squealer tip rail extending outward from the tip floor,
wherein the tip cap is formed additively via layer-by-layer deposition of material directly over the tip floor such that the at least one squealer tip rail comprises an embedded cooling channel formed therein,
wherein the embedded cooling channel is aligned with and fluidically connected to the at least one cooling hole formed through the tip floor of the airfoil section, the embedded cooling channel having one or more outlets located on at least one of a side face and a top face of the at least one squealer tip rail.

13. The method according to claim 12, wherein the airfoil section is formed by casting.

14. The method according to claim 13, wherein the at least one cooling hole is formed by drilling through the tip floor of the airfoil section.

15. A method for refurbishing a turbine blade, comprising:
removing material from a tip portion of the turbine blade up to a specified depth, to define a tip floor of an airfoil section of the turbine blade,
drilling at least one cooling hole through the tip floor, the at least one cooling hole being fluidically connected to an internal coolant cavity of the airfoil section,
forming a tip cap over the tip floor, the tip cap comprising at least one squealer tip rail extending outward from the tip floor,
wherein the tip cap is formed additively via layer-by-layer deposition of material directly over the tip floor such that the at least one squealer tip rail comprises an embedded cooling channel formed therein,
wherein the embedded cooling channel is aligned with and fluidically connected to the at least one cooling hole formed through the tip floor of the airfoil section, the embedded cooling channel having one or more outlets located on at least one of a side face and a top face of the at least one squealer tip rail.
